(19) United States
(12) Patent Application Publication
(10) Pub. No.: US 2016/0189663 A1
(43) Pub. Date: Jun. 30, 2016

(54) ORGANIC LIGHT-EMITTING DISPLAY AND METHOD OF DRIVING THE SAME

(71) Applicant: Samsung Display Co., Ltd, Yongin-city (KR)

(72) Inventors: Young In HWANG, Suwon-si (KR); Ji Hye KONG, Yongin-si (KR); Yong Sung PARK, Seoul (KR); Tak Young LEE, Anyang-si (KR); Young Jin CHO, Seoul (KR); In Ho CHOI, Seoul (KR)

(21) Appl. No.: 14/688,668

(22) Filed: Apr. 16, 2015

(30) Foreign Application Priority Data
Dec. 29, 2014 (KR) 10-2014-0192275

(51) Int. Cl. G09G 5/00; G09G 5/02; G09G 5/18

(52) U.S. Cl. CPC G09G 5/00; G09G 5/18; G09G 5/02; G09G 2300/0426

(57) ABSTRACT

An organic light-emitting display including a data driver connected to a plurality of data lines disposed in a first direction, a scan driver connected to a plurality of scan lines disposed in a second direction intersecting the first direction, and a display panel including a pixel group which includes first through fourth pixel units respectively connected to j-th through (j+3)-th data lines among the data lines. The first through fourth pixel units are connected to an i-th scan line among the scan lines and disposed in the first direction, where i and j are natural numbers equal to or greater than one.

### CROSS-REFERENCE TO RELATED APPLICATION

This application claims priority from and the benefit of Korean Patent Application No. 10-2014-0192275, filed on Dec. 29, 2014, which is hereby incorporated by reference for all purposes as if fully set forth herein.

### BACKGROUND

1. Field

Exemplary embodiments relate to an organic light-emitting display and a method of driving the same.

2. Discussion of the Background

An organic light-emitting display, which is drawing attention as a next-generation display, displays an image using an organic light-emitting diode that emits light by recombination of electrons and holes. The organic light-emitting display has advantages of high response speed, high luminance, a wide viewing angle, and low power consumption.

The organic light-emitting display controls the amount of current provided to the organic light-emitting diode using a driving transistor included in each pixel and generates light having specific luminance according to the amount of current provided to the organic light-emitting diode.

However, as the resolution of organic light-emitting displays increases, the number of data lines and the number of data driver integrated circuits (ICs) also increase, thereby increasing manufacturing costs and making it difficult to produce small-sized organic light-emitting displays.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an organic light-emitting display in which a predetermined number of pixel units having respective long sides disposed in a horizontal direction are set as one pixel group, and in which the same scan signal is provided to one pixel group.

Exemplary embodiments also provide a method of driving an organic light-emitting display in which a predetermined number of pixel units having respective long sides disposed in a horizontal direction are set as one pixel group, and in which the same scan signal is provided to one pixel group.

Additional aspects will be set forth in the detailed description which follows, and, in part, will be apparent from the disclosure, or may be learned by practice of the inventive concept.

An exemplary embodiment of the present invention discloses an organic light-emitting display including a data driver connected to a plurality of data lines disposed in a first direction; a scan driver connected to a plurality of scan lines disposed in a second direction intersecting the first direction; and a display panel including a pixel group including first through fourth pixel units respectively connected to j-th through (j+3)-th data lines among the data lines. The first through fourth pixel units are connected to an i-th scan line among the scan lines and disposed in the first direction, where i and j are natural numbers equal to or greater than one.

An exemplary embodiment of the present invention also discloses an organic light-emitting display including a data driver that provides a plurality of data signals to a plurality of data lines disposed in a first direction; a scan driver that provides a plurality of scan signals to a plurality of scan lines disposed in a second direction intersecting the first direction; and a display panel including a pixel group that includes first through fourth pixel units receiving j-th through (j+3)-th data signals among the data signals. The first through fourth pixel units are disposed in the first direction within the display panel and receive an i-th scan signal among the scan signals, where i and j are natural numbers equal to or greater than one.

An exemplary embodiment of the present invention also discloses a method of driving an organic light-emitting display including establishing signal paths respectively between j-th through (j+3)-th data lines among the data lines and the first through fourth pixel units in response to an i-th scan signal received from an i-th scan line among the scan lines; and letting first through fourth organic light-emitting diodes respectively included in the first through fourth pixel units emit light according to voltages corresponding to j-th through (j+3)-th data signals received from the j-th through (j+3)-th data lines. The first through fourth pixel units are disposed in the display panel in a first direction in which the j-th through (j+3)-th data lines are disposed in the display panel, where i and j are natural numbers equal to or greater than one.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram of an organic light-emitting display according to an exemplary embodiment of the present invention.

FIG. 2 is a detailed block diagram of a part of a display panel included in the organic light-emitting display of FIG. 1.

FIG. 3 is a circuit diagram of an embodiment of a pixel group included in the display panel of FIG. 2.

FIG. 4 is a block diagram of an organic light-emitting display according to another exemplary embodiment of the present invention.

FIG. 5 is a detailed block diagram of a display panel included in the organic light-emitting display of FIG. 4.

FIG. 6 is a graph illustrating one frame period (1H) of each of the organic light-emitting displays according to the exemplary embodiments of FIGS. 1 through 5.

FIG. 7 is a flowchart illustrating a method of driving an organic light-emitting display according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

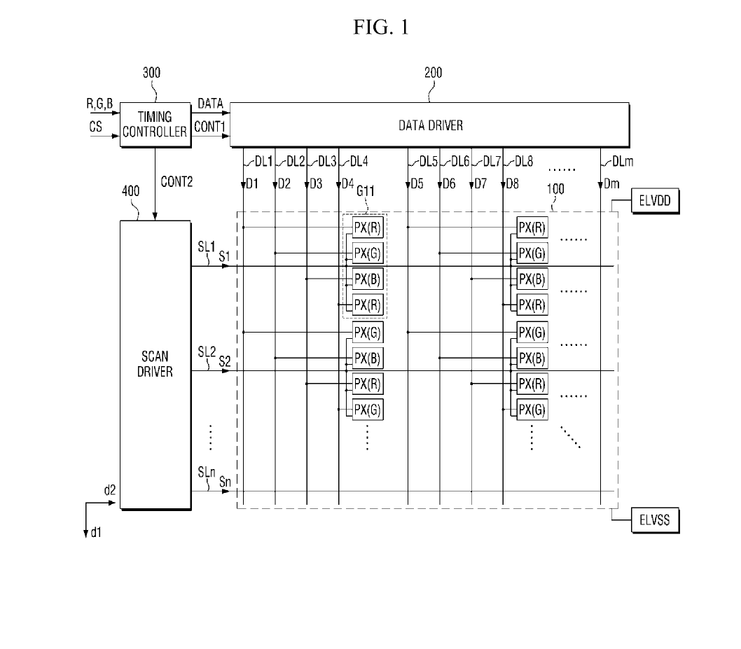

FIG. 1 is a block diagram of an organic light-emitting display according to an exemplary embodiment of the present invention.

Referring to FIG. 1, the organic light-emitting display according to the current exemplary embodiment may include a display panel 100, a data driver 200, a timing controller 300, a scan driver 400, and a power supply unit (not illustrated).

The display panel 100 may be an area in which an image is displayed. The display panel 100 may include a plurality of data lines DL1 through DLm (m is a natural number greater than one) and a plurality of scan lines SL1 through SLn (n is a natural number greater than one) intersecting the data lines DL1 through DLm. In addition, the display panel 100 may include a plurality of pixel groups G disposed at intersections of the data lines DL1 through DLm and the scan lines SL1 through SLn. The data lines DL1 through DLm, the scan lines SL1 through SLn, and the pixel groups G may be disposed on one substrate to be insulated from one another. In an exemplary embodiment, they may be arranged in a matrix. The data lines DL1 through DLm may extending a first direction d1, and the scan lines S1 through Sn may extend in a second direction d2 intersecting the first direction d1. Referring to FIG. 1, the first direction d1 may be a column direction, and the second direction d2 may be a row direction. Of the pixel groups G, a pixel group G11 connected to the first scan line SL1 and the first through fourth data lines DL1 through DL4 will hereinafter be described as an example.

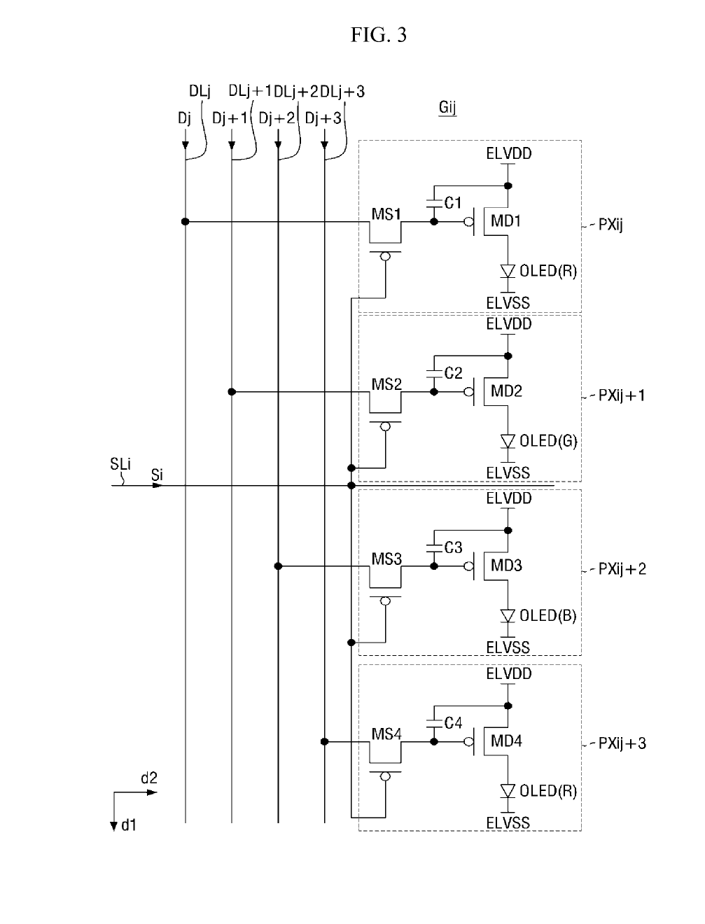

The pixel group G11 may include first, second, third, and fourth pixel units PX(R), PX(G), PX(B), and PX(R). The first, second, third, and fourth pixel units PX(R), PX(G), PX(B), and PX(R) may be connected to the first through fourth data lines DL1 through DL4, respectively, and to the first scan line SL1. The first pixel unit PX(R) may include a first organic light-emitting diode OLED (R) (see FIG. 3) which emits light of a first color, and the second pixel unit PX(G) may include a second organic light-emitting diode OLED(G) (see FIG. 3) which emits light of a second color. In addition, the third pixel unit PX(B) may include a third organic light-emitting diode OLED(B) (see FIG. 3) which emits light of a third color. In an exemplary embodiment, the first color may be red, the second color may be green, and the third color may be blue. The fourth pixel unit PX(R) may include an organic light-emitting diode which emits light of one of the first through third colors. For example, FIG. 1 illustrates case where the fourth pixel unit PX(R) includes the first organic light-emitting diode OLED(R) (see FIG. 3), which emits light of the first color. In addition, while a case where the first pixel unit PX(R) of the pixel group G11 includes the first organic light-emitting diode OLED(R) which emits light of the first color is described as an example in FIG. 1, the present invention is not limited to this case. For example, in a pixel group G21, a pixel unit PX(G) located at a position corresponding to the first pixel unit PX(R) of the pixel group G11 may include an organic light-emitting diode which emits light of the second color. That is, each of the pixel groups G may include organic light-emitting diodes which emit light of the first through third colors, and may further include an organic light-emitting diode which emits light of one of the first through third colors. Each of the pixel groups G may be connected to a first power supply terminal ELVDD by a first power supply line and may be connected to a second power supply terminal ELVSS by a second power supply line. First through fourth driving transistors MD1 through MD4 (see FIG. 3) respectively included in the first, second, third, and fourth pixel units PX(R), PX(G), PX(B), and PX(R) may control the amount of current flowing from the first power supply terminal ELVDD to the second power supply terminal ELVSS in response to first through fourth data signals D1 through D4 received from the first through fourth data lines DL1 through DL4.

The data driver 200 may be connected to the display panel 100 by the data lines DL1 through DLm. Under the control of the timing controller 300, the data driver 200 may provide a plurality of data signals D1 through Dm through the data lines DL1 through DLm. That is, the data driver 200 may provide the data signals D1 through Dm to pixel units selected according to the scan signals S1 through Sn. Each of the pixel groups G may be turned on by a scan signal at a low level, and may display an image by emitting light in response to data signals received from the data driver 200.

The timing controller 300 may receive a control signal CS and an image signal R, G, B from an external system. The control signal CS may include a vertical synchronization signal Vsync and a horizontal synchronization signal Hsync. The image signal R, G, B includes luminance information of each of a plurality of pixel units. The luminance information may have 1024, 256, or 64 gray levels. The timing controller 300 may generate image data DATA by dividing the image signal R, G, B on a frame-by-frame basis according to the vertical synchronization signal Vsync and dividing the image signal R, G, B on a scan line-by-scan line basis according to the horizontal synchronization signal Hsync. The timing controller 300 may provide control signals CONT1 and CONT2 respectively to the data driver 200 and the scan driver 400 in response to the control signal CS and the image signal R, G, B. The timing controller 300 may provide the image data DATA to the data driver 200 together with the control signal CONT1, and the data driver 200 may generate the data signals D1 through Dm by sampling and holding the input image data DATA and converting the image data DATA into analog voltages according to the control signal CONT1. Then, the data driver 200 may transmit the data signals D1 through Dm to a plurality of pixel units through the data lines DL1 through DLm.

The scan driver 400 may be connected to the display panel 100 by the scan lines SL1 through SLn. The scan driver 400 may sequentially transmit a plurality of scan signals S1 through Sn to the scan lines SL1 through SLn according to the control signal CONT2 received from the timing controller 300. Here, the first through fourth data lines DL1 through DL4 and the first scan line SL1 may be connected to the same pixel group G. That is, one pixel group G may be connected to four data lines and one scan line. For example, the first, second, third, and fourth pixel units PX(R), PX(G), PX(B), and PX(R) included in the pixel group G11 may receive the first scan signal S1 from the first scan line SL1 and emit light according to voltages corresponding to the first through fourth data signals D1 through D4 received from the first through fourth data lines DL1 through DL4.

The power supply unit (not illustrated) may provide a driving voltage to each pixel unit included in each of the pixel groups G according to a control signal received from the timing controller 300. Here, the first and second power supply terminals ELVDD and ELVSS may provide driving voltages to the pixel groups G via the first and second power supply lines. In this case, a voltage provided by the first power supply terminal ELVDD may be at a high level, and a voltage provided by the second power supply terminal ELVSS may be at a low level. The first power supply terminal ELVDD and the voltage provided by the first power supply terminal ELVDD will hereinafter be indicated by reference character ELVDD, and the second power supply terminal ELVSS and the voltage provided by the second power supply terminal ELVSS will hereinafter be indicated by reference character ELVSS.

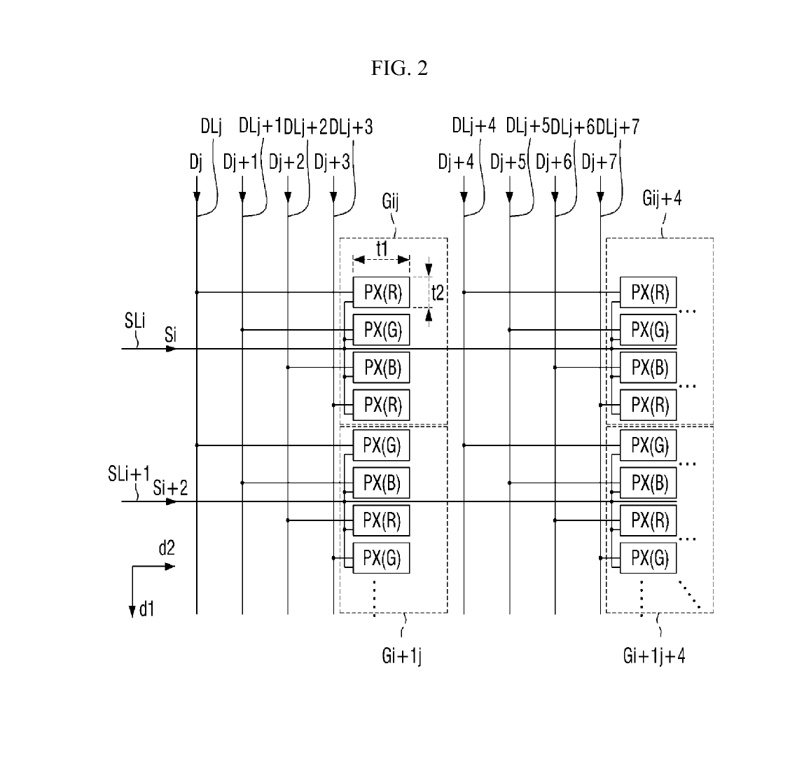

FIG. 2 is a detailed block diagram of a part of the display panel 100 included in the organic light-emitting display of FIG. 1. The part of the display panel 100 illustrated in the block diagram of FIG. 2 includes a pixel group Gij which is connected to an i^{th} scan line SLi and each of j^{th} through (j+3)^{th} data lines DLj through DLj+3, a pixel group Gi+1j which is connected to an (i+1)^{th} scan line SLi+1 and each of the j^{th} through (j+3)^{th} data lines DLj through DLj+3, a pixel group Gij+4 which is connected to the i^{th} scan line SLi and each of (j+4)^{th} through (j+7)^{th} data lines DLj+4 through DLj+7, and a pixel group Gi+1j+4 which is connected to the (i+1)^{th} scan line SLi+1 and each of the (j+4)^{th} through (j+7)^{th} data lines DLj+4 through DLj+7, where i and j are natural numbers equal to or greater than one.

As illustrated in FIG. 2, in the organic light-emitting display according to the current exemplary embodiment, a length t1 of each pixel unit may be greater than a width t2 thereof. That is, since a horizontal length t1 of each pixel unit is greater than a vertical length t2 (t1>t2), red (i.e., the first color), green (i.e., the second color) and blue (i.e., the third color) may be arranged in the form of a horizontal stripe on the display panel 100. More specifically, in the display panel 100, pixel units emitting light of the first through third colors may be repeatedly arranged along a plurality of data lines (e.g., DL1 through DL4). For example, the first, second, third, and fourth pixel units PX(R), PX(G), PX(B), and PX(R) may be arranged adjacent to each other in the first direction d1, that is, in the column direction to form one pixel group Gij. Accordingly, the number of integrated circuits (ICs) that constitute the data driver 200 and the size of a data printed circuit board (PCB) can be reduced. In addition, the first, second, third, and fourth pixel units PX(R), PX(G), PX(B), and PX(R) included in the pixel group Gij may be disposed between the (j+3)^{th} data line DLj+3 and the (j+4)^{th} data line DLj+4 in the display panel 100. The pixel group Gij may be connected to the i^{th} scan line SLi. Accordingly, the first, second, third, and fourth pixel units PX(R), PX(G), PX(B) and PX(R) may be driven simultaneously by an i^{th} scan signal Si. That is, since four pixel units are connected to one scan line, the total number of scan lines can be reduced, thereby increasing one frame period 1H.

FIG. 3 is a circuit diagram of an exemplary embodiment of the pixel group Gij included in the display panel 100 of FIG. 2. While a circuit diagram of the pixel group Gij illustrated in FIG. 2 is provided as an example in FIG. 3, other pixel groups can also have circuit diagrams structured in the same way as the circuit diagram of the pixel group Gij.

Referring to FIG. 3, the pixel group Gij according to the current exemplary embodiment may include first through fourth pixel units PXij through PXij+3. For simplicity, a description of elements of the second through fourth pixel units PXij+1 through PXij+3, which are identical to those of the first pixel unit PXij, will be omitted.

The first pixel unit PXij may include a first switching transistor MS1, a first driving transistor MD1, a first capacitor C1, and an organic light-emitting diode OLED(R) which emits light of the first color. The first switching transistor MS1 may have a first electrode connected to the j^{th} data line DLj, a second electrode connected to a gate electrode of the first driving transistor MD1, and a gate electrode connected to the i^{th} scan line SLi. The first switching transistor MS1 may be turned on by the i^{th} scan signal Si at a low level transmitted to the i^{th} scan line SLi and provide a voltage corresponding to a j^{th} data signal Dj received through the j^{th} data line DLj to the first capacitor C1. Here, the first switching transistor MS1 may be a p-channel field effect transistor. That is, the first switching transistor MS1 may be turned on by a scan signal at a low level and turned off by a scan signal at a high level. In addition, the first driving transistor MD1 may be a p-channel field effect transistor. However, the present invention is not limited thereto, and the first switching transistor MS1 and the first driving transistor MD1 may also be n-channel field effect transistors. The first driving transistor MD1 may have a first electrode connected to the first power supply terminal ELVDD, a second electrode connected to the organic light-emitting diode OLED(R), and the gate electrode connected to the second electrode of the first switching transistor MS1. The first driving transistor MD1 may control the amount of driving current flowing from the first power supply terminal ELVDD to the second power supply terminal ELVSS via the organic light-emitting diode OLED(R) according to a voltage charged in the first capacitor C1. The first capacitor C1 may have a first terminal connected to the second electrode of the first switching transistor MS1 and a second terminal connected to the first power supply terminal ELVDD. The first capacitor C1 may be charged with a voltage corresponding to a difference between voltages applied to the first and second terminals thereof. The organic light-emitting diode OLED(R) which emits light of the first color may include an anode connected to the second electrode of the first driving transistor MD1, a cathode connected to the second power supply terminal ELVSS, and an organic light-emitting layer. The organic light-emitting layer may emit light of one of primary colors, and the organic light-emitting diode OLED(R) included in the first pixel unit PXij may emit light of a red color, which may be the first color in an exemplary embodiment.

The second pixel unit PXij+1 may include a second switching transistor MS2, a second driving transistor MD2, a second capacitor C2, and an organic light-emitting diode OLED(G), which emits of the second color. The second switching transistor MS2 may have a first electrode connected to the (j+l)^{th} data line Dj+1 and a gate electrode connected to the i^{th} scan line SLi. That is, the second switching transistor MS2 may be turned on by the i^{th} scan signal Si at a low level transmitted to the i^{th} scan line SLi and provide a voltage corresponding to a (j+1)^{th} data signal Dj+1 received through the (j+l)^{th} data line DLj+l to the second capacitor C2. Accordingly, the organic light-emitting diode OLED(G) included in the second pixel unit PXij+l may emit light of green, which may be the second color in an exemplary embodiment.

The third pixel unit PXij+2 may include a third switching transistor MS3, a third driving transistor MD2, a third capacitor C3, and an organic light-emitting diode OLED(B) which emits light of the third color. The third switching transistor MS3 may have a first electrode connected to the (j+2)^{th} data line Dj+2 and a gate electrode connected to the i^{th} scan line SLi. That is, the third switching transistor MS3 may be turned on by the i^{th} scan signal Si at a low level transmitted to the i^{th} scan line SLi and provide a voltage corresponding to a (j+2)^{th} data signal Dj+2 received through the (j+2)^{th} data line DLj+2 to the third capacitor C3. Accordingly, the organic light-emitting diode OLED(G) included in the third pixel unit PXij+2 may emit light of blue, which may be the third color in an exemplary embodiment.

The fourth pixel unit PXij+3 may include a fourth switching transistor MS4, a fourth driving transistor MD4, a fourth capacitor C4, and an organic light-emitting diode OLED(R, which emits light of the first color. The fourth switching transistor MS4 may have a first electrode connected to the (j+3)^{th} data line Dj+3 and a gate electrode connected to the i^{th} scan line SLi. That is, the fourth switching transistor MS4 may be turned on by the i^{th} scan signal Si at a low level transmitted to the i^{th} scan line SLi and provide a voltage corresponding to a (j+3)^{th} data signal Dj+3 received through the (j+3)^{th} data line DLj+3 to the fourth capacitor C4. Accordingly, the organic light-emitting diode OLED(R) included in the fourth pixel unit PXij+3 may emit light of red, which may be the first color in an exemplary embodiment.

That is, the first through fourth pixel units PXij through PXij+3 may be disposed in the display panel 100 in the same direction as the first direction d1 in which the first through fourth data lines DL1 through DL4 are disposed in the display panel 100. In addition, as the first through fourth switching transistors MS1 through MS4 are turned on simultaneously by the i^{th} scan signal Si, the organic light-emitting diodes may emit light according to the i^{th} through (j+3)^{th} data signals Dj through Dj+3 received through the j^{th} through (j+3)^{th} data lines DLj through DLj+3, respectively. Other pixel groups may also have the same structure as the pixel group Gij although they are connected to different scan lines and data lines. However, the circuit of each pixel unit included in each pixel group is not limited to the example illustrated in FIG. 3.

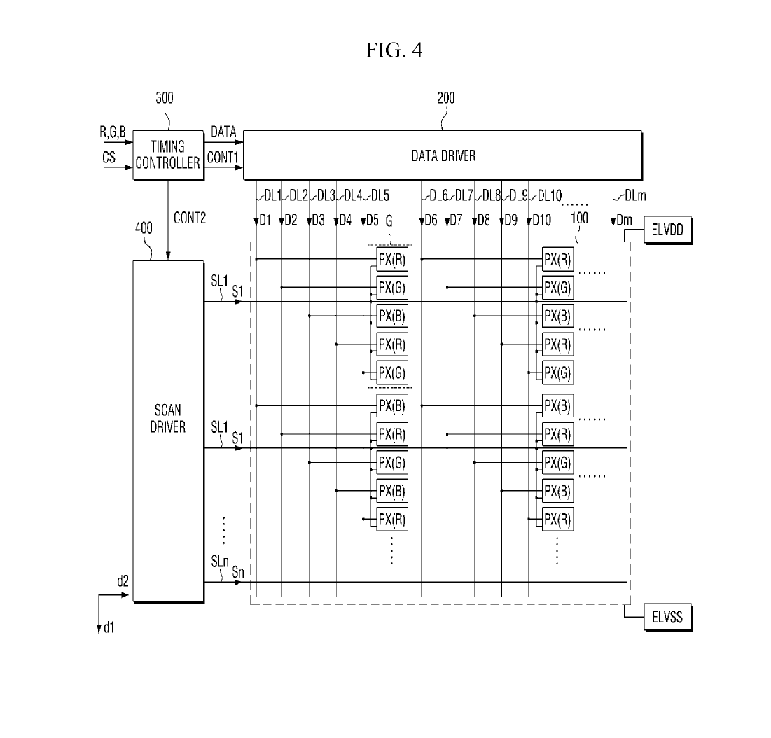

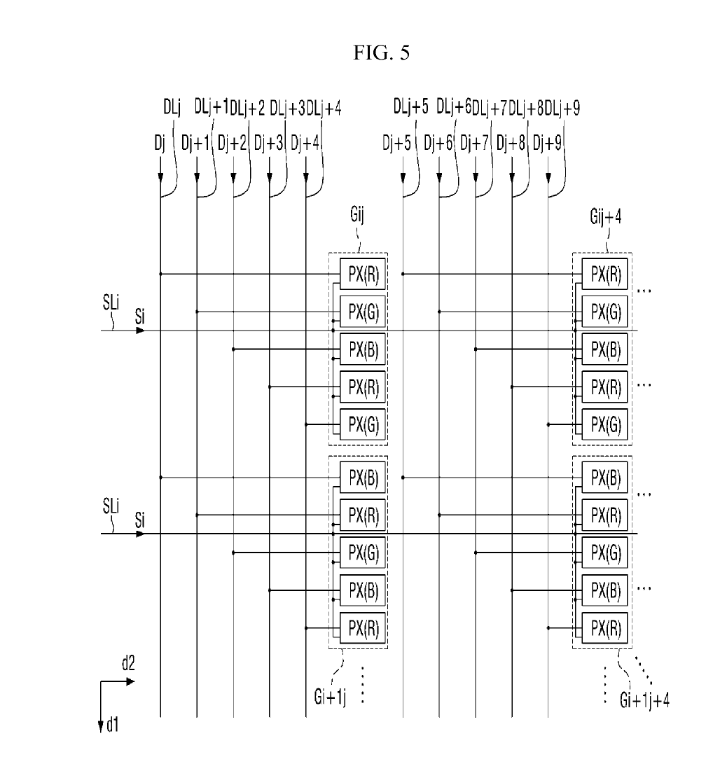

FIG. 4 is a block diagram of an organic light-emitting display according to another exemplary embodiment of the present invention. FIG. 5 is a detailed block diagram of a display panel 100 included in the organic light-emitting display of FIG. 4.

Referring to FIGS. 4 and 5, the organic light-emitting display according to the current exemplary embodiment is different from the organic light-emitting display according to the previous exemplary embodiment of FIGS. 1 through 3 in that a pixel group G is connected to five data lines. For example, a pixel group G11 may be connected to first through fourth data lines DL1 through DL4, and also to a fifth data line DL5. Accordingly, the pixel group G11 may further include a fifth pixel unit PX(G). The fifth pixel unit PX(G) may emit light of one of first through third colors, which is different from a color of light emitted by a fourth pixel unit PX(R). In an exemplary embodiment, the fifth pixel unit PX(G) may emit light of the second color, i.e., green. In addition, first, second, third, fourth, and fifth pixel groups PX(R), PX(G), PX(B), PX(R), and PX(G) may be disposed in the display panel 100 between the fifth data line DL5 and a sixth data line DL6. The organic light-emitting display according to the current exemplary embodiment are the same as the organic light-emitting display according to the previous exemplary embodiment of FIGS. 1 through 3 in that each of the first, second, third, fourth, and fifth pixel groups PX(R), PX(G), PX(B), PX(R), and PX(G) is connected to a first scan line SL1 to receive a first scan signal S1.

In the organic light-emitting display according to the current exemplary embodiment, one more additional data line is connected to each pixel group than in the organic light-emitting display according to the previous exemplary embodiment. Therefore, the total number of scan lines may be smaller, ensuring a longer frame period 1H.

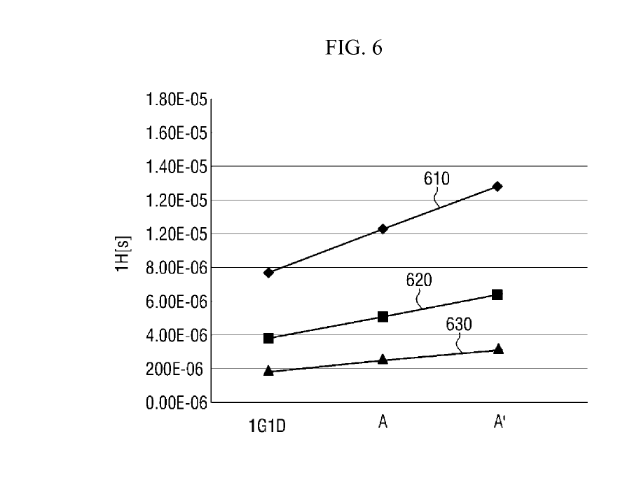

FIG. 6 is a graph illustrating one frame period 1H of each of the organic light-emitting displays according to the exemplary embodiments of FIGS. 1 through 5. Here, 1G1D represents one frame period 1H of a conventional organic light-emitting display in which one pixel unit is connected to one scan line and one data line, and A represents one frame period 1H of the organic light-emitting display according to the embodiment of FIGS. 1 through 3. In addition, A′ represents one frame period 1H of the organic light-emitting display according to the embodiment of FIGS. 4 and 5. Reference numeral 610 represents full high definition (FHD) resolution, reference numeral 620 represents ultra-high definition (UHD) resolution, and reference numeral 630 represents quad high definition (QHD) resolution. In the case of the conventional organic light-emitting display 1G1D, the number of scan lines may be 2160 based on the UHD 620 of 120 Hz, and one frame period 1H may be 3.86 μs.

Referring to FIG. 6, the organic light-emitting display A or A′ according the exemplary embodiment of FIGS. 1 through 3 or the exemplary embodiment of FIGS. 4 and 5 may have a longer frame period 1H for each of the FHD 610, the UHD 620, and the QHD 630 than the conventional organic light-emitting display 1G1D. More specifically, the number of scan lines included in the organic light-emitting device A according to the exemplary embodiment of FIGS. 1 through 3 may be reduced to a quarter of the number of scan lines included in the conventional organic light-emitting display 1G1D. That is, in the case of the organic light-emitting display A according to the exemplary embodiment of FIGS. 1 through 3, the number of scan lines may be reduced to 1620 based on the UHD 620 of 120 Hz. Accordingly, one frame time 1H may increase to 5.14 μs. In the case of the organic light-emitting display A′ according to the exemplary embodiment of FIGS. 4 and 5, the number of scan lines may be further reduced to 1296 based on the UHD 620 of 120 Hz. Accordingly, one frame period H1 may increase to 6.43 μs.

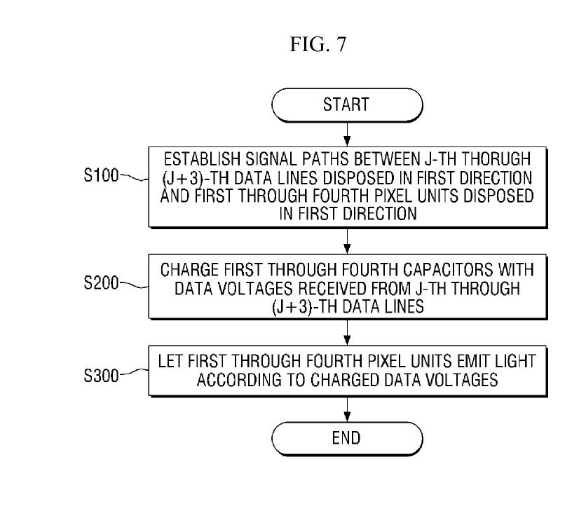

FIG. 7 is a flowchart illustrating a method of driving an organic light-emitting display according to an exemplary embodiment of the present invention. The pixel group Gij illustrated in FIG. 3 will be described below as an example.

Referring to FIGS. 1, 3 and 7, in the method of driving an organic light-emitting display according to the current exemplary embodiment, first through fourth switching transistors MS1 through MS4 may be turned on by an i^{th} scan signal Si that a pixel group Gij receives through an i^{th} scan line SLi, where i is a natural number equal to or greater than one.

Accordingly, signal paths between j^{th} through (j+3)^{th} data lines DLj through DLj+3 and first through fourth pixel units PXij through PXij+3, respectively, may be established (operation S100). Then, voltages corresponding to j^{th} through (j+3)^{th} data signals D1 through Dj+3 may be charged in first through fourth capacitors C1 through C4 (operation S200). Next, organic light-emitting diodes included in the first through fourth pixel units PXij through PXij+3 may emit light according to the voltages charged in the first through fourth capacitors C1 through C4, respectively (operation S300). Here, the first through fourth pixel units PXij through PXij+3 may be arranged in a display panel 100 in the same direction as a first direction d1 in which a plurality of data lines DL1 through DLm are arranged in the display panel 100. In addition, a horizontal side of each pixel unit may be longer than a vertical side thereof. Accordingly, pixel units having the same color may be arranged in the display panel 100 along a second direction d2. In an exemplary embodiment, the first through fourth pixel units PXij through PXij+3 may be disposed between the (j+3)^{th} data line DLj+3 and a (Dj+4)th data line DLj+4.

The present invention provides the following advantages.

A long side of each pixel is disposed in a horizontal direction, and a pixel group having a predetermined number of pixel units is driven using one scan signal. Therefore, the total number of scan lines can be reduced.

Because the total number of scan lines is reduced, one frame period (1H) can be secured, and the area occupied by data lines can be minimized.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An organic light-emitting display comprising:
a data driver connected to a plurality of data lines disposed in a first direction;
a scan driver connected to a plurality of scan lines disposed in a second direction intersecting the first direction; and
a display panel comprising a pixel group which comprises first through fourth pixel units respectively connected to j-th through (j+3)-th data lines among the data lines,
wherein the first through fourth pixel units are connected to an i-th scan line among the scan lines and disposed in the first direction, where i and j are natural numbers equal to or greater than one.

2. The organic light-emitting display of claim 1, wherein the first through third pixel units respectively comprise organic light-emitting diodes configured to emit light of first through third different colors, and the fourth pixel unit comprises an organic light-emitting diode configured to emit light of one of the first through third colors.

3. The organic light-emitting display of claim 2, wherein the first through fourth pixel units further comprise:
first through fourth switching transistors comprising respective gate electrodes connected to a scan signal received from the i-th scan line and respective first electrodes connected to the j-th through (j+3)-th data lines, respectively;
first through fourth driving transistors comprising respective gate electrodes connected to respective second electrodes of the first through fourth switching transistors and respective first electrodes connected to a first power supply terminal; and
first through fourth capacitors comprising respective first terminals connected to the respective first electrodes of the first through fourth driving transistors and respective second terminals connected to the first power supply terminal.

4. The organic light-emitting display of claim 1, wherein each of the first through fourth pixel units is disposed in the display panel such that a widthwise direction thereof is parallel to the first direction and a lengthwise direction thereof is parallel to the second direction.

5. The organic light-emitting display of claim 1, wherein the first direction is a column direction, and the second direction is a row direction.

6. The organic light-emitting display of claim 1, wherein the data lines further comprise a (j+4)-th data line disposed in the first direction, and the first through fourth pixel units are disposed between the (j+3)-th data line and the (j+4)-th data line in the display panel.

7. The organic light-emitting display of claim 1, wherein the pixel group further comprises a fifth pixel unit which is connected to the (j+4)-th data line and the i-th scan line, wherein the fifth pixel unit is disposed in the first direction.

8. The organic light-emitting display of claim 7, wherein:
the first through third pixel units respectively comprise organic light-emitting diodes configured to emit light of first through third different colors;
the fourth pixel unit comprises an organic light-emitting diode configured to emit light of one of the first through third colors; and
the fifth pixel unit comprises an organic light-emitting diode configured to emit light of a color different from the color of the light emitted from the fourth pixel unit.

9. The organic light-emitting display of claim 7, wherein the data lines further comprise a (j+5)-th data line disposed in the first direction, and the first through fifth pixel units are disposed between the (j+4)-th data line and the (j+5)-th data line in the display panel.

10. An organic light-emitting display comprising:
a data driver configured to provide a plurality of data signals to a plurality of data lines disposed in a first direction;
a scan driver configured to provide a plurality of scan signals to a plurality of scan lines disposed in a second direction intersecting the first direction; and
a display panel comprising a pixel group which comprises first through fourth pixel units configured to receive j-th through (j+3)-th data signals among the data signals,
wherein the first through fourth pixel units are disposed in the first direction within the display panel and are configured to receive an i-th scan signal among the scan signals, where i and j are natural numbers equal to or greater than one.

11. The organic light-emitting display of claim 10, wherein the first through third pixel units respectively comprise first through third organic light-emitting diodes configured to emit light of first through third different colors, and the fourth pixel unit comprises a fourth organic light-emitting diode configured to emit light of one of the first through third colors.

12. The organic light-emitting display of claim 11, wherein the first through fourth pixel units further comprise:
first through fourth switching transistors configured to be turned on by the i-th scan signal;
first through fourth driving transistors configured to control amounts of driving current flowing from a first power supply terminal to the first through fourth organic light-emitting diodes in response to the j-th through (j+3)-th data signals, respectively; and
first through fourth capacitors configured to be charged with voltages corresponding to the j-th through (j+3)-th data signals, respectively.

13. The organic light-emitting display of claim 10, wherein each of the first through fourth pixel units is disposed in the display panel such that a widthwise direction thereof is parallel to the first direction and that a lengthwise direction thereof is parallel to the second direction.

14. The organic light-emitting display of claim 10, wherein the first direction is a column direction, and the second direction is a row direction.

15. The organic light-emitting display of claim 10, wherein:
the pixel group further comprises a fifth pixel unit configured to receive a (j+4)-th data signal and the i-th scan signal; and
the fifth pixel unit is disposed in the first direction.

16. The organic light-emitting display of claim 15, wherein:
the first through third pixel units respectively comprise first through third organic light-emitting diodes configured to emit light of first through third different colors;
the fourth pixel unit comprises a fourth organic light-emitting diode configured to emit light of one of the first through third colors; and
the fifth pixel unit comprises a fifth organic light-emitting diode configured to emit light of a color different from the color of the light emitted from the fourth pixel unit.

17. A method of driving an organic light-emitting display which comprises a display panel comprising first through fourth pixel units and connected to a plurality of data lines and a plurality of scan lines, the method comprising:
establishing signal paths respectively between j-th through (j+3)-th data lines among the data lines and the first through fourth pixel units in response to an i-th scan signal received from an i-th scan line among the scan lines; and
causing first through fourth organic light-emitting diodes respectively included in the first through fourth pixel units emit light according to voltages corresponding to j-th through (j+3)-th data signals received from the j-th through (j+3)-th data lines,
wherein the first through fourth pixel units are disposed in the display panel in a first direction in which the j-th through (j+3)-th data lines are disposed in the display panel, where i and j are natural numbers equal to or greater than one.

18. The method of claim 17, wherein the first direction intersects a second direction in which the scan lines are disposed.

19. The method of claim 17, wherein the first through third organic light-emitting diodes emit light of first through third different colors, respectively, and the fourth organic light-emitting diode emits light of one of the first through third colors.

20. The method of claim 17, wherein the data lines further comprise a (j+4)-th data line disposed in the first direction, and the first through fourth pixel units are disposed between the (j+3)-th data line and the (j+4)-th data line in the display panel.
